(19) United States
(12) Patent Application Publication
(10) Pub. No.: US 2009/0017311 A1
(43) Pub. Date: Jan. 15, 2009

(54) Two-Component Polyurethane Composition With High Early Strength

(75) Inventor: Stefan Kislig, Widen (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/223,810

(22) PCT Filed: May 9, 2007
(86) PCT No.: PCT/EP2007/054467

§ 371 Date: Sep. 4, 2008

(30) Foreign Application Priority Data
May 9, 2006 (EP) 06113651.1

(51) Int. Cl. B32B 27/40; C08G 18/08; C08L 75/00; C09J 175/12

(52) U.S. Cl. 428/423.1; 524/589; 524/591; 156/331.4

(57) ABSTRACT

The invention relates to two-component polyurethane compositions with high early strength, consisting of a first component A that hardens even by itself by reaction with atmospheric moisture, and a second component B that contains water and an acid.

### FIELD OF THE INVENTION

The invention relates to two-component polyurethane compositions having a high early strength and suitable as elastic adhesives, sealants or coatings.

### BACKGROUND ART

The uses to which polyurethane compositions are put include their use for a variety of adhesive bonds, seals and coatings. They are especially suitable for adhesive bonds or seals which necessitate elasticity in the bond. For certain adhesive applications it is necessary for the adhesive bond to be exposed to mechanical load just a short time after the adhesive has been applied; for the reason, for example, that the bonded components are to be moved, or that some fixing is to be removed. In order to allow such premature loading, the adhesive bond is required to have a very high “early strength”, in other words to be capable of being loaded in a certain way at a point in time at which the adhesive has only partly cured. The requirements which are imposed in practice on the early strength of an adhesive bond vary greatly and depend more particularly on the specific manufacturing operation, on the weight of the bonded components, and on the nature of the mechanical load.

Elastic adhesives based on conventional two-component polyurethane compositions can be used to attain high early strength relatively quickly, especially when the component containing isocyanate groups is combined with a second component which contains primary or secondary amino groups. Such two-component polyurethane compositions, however, are complicated to manage. The defined mixing ratio between the two components must be observed precisely, since otherwise the adhesive does not cure in the manner desired and, consequently, a deficient adhesive bond is produced, which does not attain the requisite strength. The mixing of the two components, moreover, must be very rapid and efficient, owing to the very high reactivity of the amino groups with the isocyanate groups, and does not allow interruptions to the operation, since otherwise the mixer becomes clogged.

Easier to manage are one-component polyurethane compositions. They contain polyurethane polymers with terminal isocyanate groups, which react on contact with water in the form of atmospheric moisture and so undergo crosslinking. Since curing takes place through contact with atmospheric moisture, these adhesives cure from the outside in, the cure rate decreasing toward the inside, on account of the fact that the water that is required for curing has to diffuse through the increasingly thicker layer of cured material. Because of the relatively slow curing, the early strengths achievable with such one-component polyurethane compositions are unsatisfactory.

In order to solve the problem of the poor availability of water and hence slow curing in a one-component polyurethane composition, systems were developed in which water, in the form of a hydrous second component, is mixed into a one-component polyurethane composition, as described for example in EP 0 678 544 B1. These systems do cure more quickly; however, they have the disadvantage that, in the course of curing, they tend to develop bubbles, which adversely affect the strength and the adhesion of an adhesive bond.

In addition there are one-component polyurethane compositions which comprise “latent curatives” or “latent polyamines”, in the form for example of polyaldimines, which serve as moisture-activable crosslinkers for isocyanate-containing polyurethane compositions. The use of a latent curative in isocyanate-containing systems has the advantage that the formation of unwanted gas bubbles in the cured polymer can be avoided, since the curing reaction via the latent curative—in contrast to the direct reaction of the isocyanate with moisture—is not accompanied by release of carbon dioxide (CO₂). In addition, latent curatives may increase the cure rate.

To increase the cure rate and the early strength it is additionally possible in the one-component polyurethane compositions to use catalysts which accelerate the hydrolysis of the latent curative or the reaction between isocyanate groups and water. The use of a catalyst has the disadvantage, however, that the storage stability of the isocyanate-containing composition may be reduced, by the increased triggering during storage of unwanted reactions between the reactive groups, more particularly the isocyanate groups. This occurs particularly when large amounts of catalysts are to be used in order to achieve the rapid curing required in order to attain high early strength.

WO 03/059978 A1 describes two-component polyurethane compositions of high early strength which cure without the formation of bubbles. The first component is composed of a polyurethane composition comprising aldimines, which is able to cure with atmospheric humidity even on its own, i.e., without a second component. The second component comprises water bound to a carrier material. These compositions cure without the formation of bubbles and have the advantage that the mixing ratio of the two components need not be observed exactly. As mentioned above, the catalyzability of the isocyanate-containing first component is limited, however, on grounds of storage stability, and so the rate of cure of such compositions remains restricted. For applications which need a high early strength at a very early point in time, these polyurethane compositions are unsuitable.

### BRIEF DESCRIPTION OF THE INVENTION

It is an object of the present invention, therefore, to provide a two-component polyurethane composition which is suitable as an elastic adhesive or sealant, which cures quickly and without bubbles, and which thus allows adhesive bonds which possess a very high early strength.

This object is achieved by means of a two-component composition composed of a) a first component A comprising (i) at least one polyurethane polymer P containing isocyanate groups and (ii) at least one latent polyamine LA; and b) a second component B comprising (i) at least one acid K and (ii) water. Component A cures with atmospheric moisture even on its own.

Such a two-component composition produces practical elastic adhesives or sealants which rapidly attain a very high early strength and are more flexible in their application than existing systems.

The acid present in component B catalyzes the hydrolysis and hence the release of the latent polyamine LA contained within component A, thus producing sharp acceleration of curing, and hence allows adhesive bonds which exhibit high strength at a very early point in time. With this system it is possible, with the same storage-stable component A, to meet sharply differing requirements with regard to cure rate, more particularly the early strength, by modifying the proportion of component B in such a way as to achieve the desired cure rate, or by using a component B having an acid K content adapted to the desired cure rate.

### SOME EMBODIMENTS OF THE INVENTION

The invention provides two-component compositions composed of
a) a first component A, which cures with moisture even on its own, comprising (i) at least one polyurethane polymer P containing isocyanate groups and (ii) at least one latent polyamine LA, and
b) a second component B comprising (i) at least one acid K and (ii) water.

Substance names beginning with “poly”, such as polyaldimine, polyamine, polyisocyanate or polyol, refer in the present document to substances which formally contain two or more per molecule of the functional groups that occur in their name.

The term “polymer” in the present document embraces on the one hand a collective of macromolecules which, while being chemically uniform, differ in respect of degree of polymerization, molar mass, and chain lengths, and have been prepared by means of a polymerization reaction (addition polymerization, polyaddition or polycondensation). On the other hand the term also embraces derivatives of such a collective of macromolecules from polymerization reactions, in other words compounds which have been obtained by reactions, such as additions or substitutions, for example, of functional groups on existing macromolecules and which may be chemically uniform or chemically nonuniform. The term further embraces what are called prepolymers, in other words reactive oligomeric preadducts whose functional groups have participated in the synthesis of macromolecules.

The term “polyurethane polymer” embraces all polymers which are prepared by the process known as the diisocyanate polyaddition process. This also includes those polymers which are virtually or entirely free of urethane groups. Examples of polyurethane polymers are polyether-polyurethanes, polyester-polyurethanes, polyether-polyureas, polyureas, polyester-polyureas, polyisocyanurates, and polycarbodiimides.

The term “latent curative” or “latent polyamine” refers in the present text without distinction to a derivative of a polyamine having aliphatic primary and/or secondary amino groups that contains no free amino groups but instead contains exclusively blocked amino groups and which therefore does not enter into any direct reaction with isocyanates, at least for a certain time. Through contact with water, the blocked amino groups of the latent polyamine undergo complete or partial hydrolysis, whereupon the polyamine begins to react with isocyanates. In the case of polyurethane polymers containing isocyanate groups, these reactions lead to crosslinking.

An “aliphatic amino group” is an amino group which is attached to an aliphatic, cycloaliphatic or arylaliphatic radical. It therefore differs from an “aromatic amino group”, which is attached directly to an aromatic or heteroaromatic radical, such as in aniline or 2-aminopyridine, for example.

The term “primary amino group” in the present document identifies an NH₂ group which is attached to an organic radical, whereas the term “secondary amino group” identifies an NH group which is attached to two organic radicals, which may also together be part of a ring.

The two-component composition is composed of a first component A, which cures with moisture even on its own, and a second component B.

Component A comprises at least one polyurethane polymer P containing isocyanate groups.

A suitable polyurethane polymer P is obtainable for example through the reaction of at least one polyisocyanate with at least one polyol. This reaction may take place by the polyol and the polyisocyanate being reacted by typical techniques, at temperatures of 50° C. to 100° C. for example, where appropriate with the accompanying use of suitable catalysts, the polyisocyanate being metered such that its isocyanate groups are present in a stoichiometric excess in relation to the hydroxyl groups of the polyol. Advantageously the polyisocyanate is metered so as to observe an NCO/OH ratio of 1.2 to 5, more particularly one of 1.5 to 3. The NCO/OH ratio here means the ratio of the number of isocyanate groups employed to the number of hydroxyl groups employed. Preferably, after all of the hydroxyl groups of the polyol have reacted, a free isocyanate group content of 0.5% to 5% by weight remains, based on the overall polyurethanepolymer P.

Where appropriate the polyurethanepolymer P can be prepared with the accompanying use of plasticizers, the plasticizers used containing no isocyanate-reactive groups.

Examples of polyols which can be used for the preparation of a polyurethane polymer P are the following commercially customary polyols or mixtures thereof:
polyoxyalkylenepolyols, also called polyetherpolyols or oligoetherols, which are polymerization products of ethylene oxide, 1,2-propylene oxide, 1,2- or 2,3-butylene oxide, tetrahydrofuran or mixtures thereof, possibly polymerized by means of a starter molecule having two or more active hydrogen atoms, such as water, ammonia or compounds having two or more OH or NH groups such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the aforementioned compounds. Use may be made both of polyoxyalkylenepolyols which have a low degree of unsaturation (measured according to ASTM D-2849-69 and reported in milliequivalents of unsaturation per gram of polyol (meq/g)), prepared for example with the aid of what are known as double metal cyanide complex catalysts (DMC catalysts), and of polyoxyalkylenepolyols having a higher degree of unsaturation, prepared for example by means of anionic catalysts such as NaOH, KOH, CsOH or alkali metal alkoxides.
Particular suitability is possessed by polyoxyalkylenediols or polyoxyalkylenetriols, more particularly polyoxypropylenediols or polyoxypropylenetriols.
Especially suitable are polyoxyalkylenediols or polyoxyalkylenetriols having a degree of unsaturation of less than 0.02 meq/g and having a molecular weight in the range of 1000-30 000 g/mol, and also polyoxypropylenediols and -triols having a molecular weight of 400-8000 g/mol.
Likewise particularly suitable are what are known as ethylene oxide-terminated (“EO-endcapped”, ethylene oxide-endcapped) polyoxypropylenepolyols. The latter are specific polyoxypropylene-polyoxyethylene-polyols which are obtained, for example, by subjecting pure polyoxypropylenepolyols, more particularly polyoxypropylenediols and -triols, after the end of the polypropoxylation reaction, to further alkoxylation with ethylene oxide and which as a result contain primary hydroxyl groups.
Styrene-acrylonitrile- or acrylonitrile-methyl methacrylate-grafted polyetherpolyols.
Polyesterpolyols, also called oligoesterols, prepared for example from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, and also polyesterpolyols formed from lactones such as ε-caprolactone, for example.
Polycarbonatepolyols of the kind obtainable by reacting, for example, the abovementioned alcohols—those used to synthesize the polyesterpolyols—with dialkyl carbonates, diaryl carbonates or phosgene.
Polyacrylatepolyols and polymethacrylatepolyols.
Polyhydrocarbon-polyols, also called oligohydrocarbonols, such as, for example, polyhydroxy-functional ethylene-propylene, ethylene-butylene or ethylene-propylene-diene copolymers, of the kind prepared, for example, by the company Kraton Polymers, or polyhydroxy-functional copolymers of dienes such as 1,3-butanediene or diene mixtures and vinyl monomers such as styrene, acrylonitrile or isobutylene, or polyhydroxy-functional polybutadienepolyols, such as those, for example, which are prepared by copolymerization of 1,3-butadiene and allyl alcohol and which may also have been hydrogenated.
Polyhydroxy-functional acrylonitrile/polybutadiene copolymers of the kind preparable, for example, from epoxides or amino alcohols and carboxyl-terminated acrylonitrile/polybutadiene copolymers (available commercially under the name Hycar® CTBN from Noveon).

These stated polyols preferably have an average molecular weight of 250-30 000 g/mol, more particularly of 1000-30 000 g/mol, and preferably have an average OH functionality in the range from 1.6 to 3.

Further to these stated polyols it is possible to use small amounts of low molecular mass dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other polyhydric alcohols, low molecular mass alkoxylation products of the aforementioned dihydric and polyhydric alcohols, and also mixtures of the aforementioned alcohols, in preparing the polyurethane polymer P.

As polyisocyanates for the preparation of a polyurethanepolymer P containing isocyanate groups it is possible to make use of commercially customary aliphatic, cycloaliphatic or aromatic polyisocyanates, more particularly diisocyanates, examples being the following:

1,6-hexamethylenediisocyanate (HDI), 2-methylpentamethylene 1,5-diisocyanate, 2,2,4- and 2,4,4-trimethyl-1,6-hexamethylenediiso'cyanate (TMDI), 1,12-dodecamethylenediisocyanate, lysinediisocyanate and lysine ester diisocyanate, cyclohexane 1,3- and 1,4-diisocyanate and any desired mixtures of these isomers, 1-isocyanato-3,3,5-trimethyl-5-isocyanatomethylcyclohexane (i.e., isophorone diisocyanate or IPDI), perhydro-2,4,- and -4,4′-diphenylmethanediisocyanate (HMDI), 1,4-diisocyanato-2,2,6-trimethylcyclohexane (TMCDI), 1,3- and 1,4-bis(isocyanatomethyl)cyclohexane, m- and p-xylylenediisocyanate (m- and p-XDI), m- and p-tetramethyl-1,3- and -1,4-xylylenediisocyanate (m- and p-TMXDI), bis(1-isocyanato-1-methylethyl)naphthalene, 2,4- and 2,6-tolylenediisocyanate and any desired mixtures of these isomers (TDI), 4,4′-, 2,4,-, and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3,-dimethyl-4,4,-diisocyanatobiphenyl (TODI), oligomers and polymers of the aforementioned isocyanates, and also any desired mixtures of the aforementioned isocyanates. Preference is given to MDI, TDI, HDI, and IPDI.

Typically the polyurethane polymer P is present in an amount of 10%-80% by weight, preferably in an amount of 15%-50% by weight, based on the overall two-component composition.

Component A of the two-component composition comprises, in addition to the polyurethane polymer P, at least one latent polyamine LA.

Examples of suitable latent polyamines LA are polyoxazolidines, polyenamines, polyketimines, and polyaldimines. In these latent polyamines LA, oxazolidino, enamino, ketimino, and aldimino groups represent blocked amino groups.

Polyoxazolidines are compounds which contain two or more oxazolidino groups of the formula (VI)

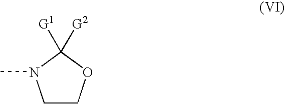

where G¹ stands for a hydrocarbon group and G² stands either for a hydrogen atom or for a hydrocarbon group.

Oxazolidino groups have the property of undergoing hydrolysis to form 2-hydroxyethylamino groups, in the course of which a ketone or an aldehyde is eliminated.

Polyoxazolidines suitable as latent polyamines LA are obtainable, for example, through the reaction of N-(2-hydroxyethyl)oxazolidines of the formula (VII)

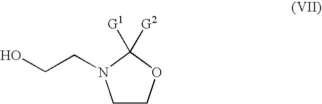

with polyisocyanates, for example. In the formula (VII) G¹ and G² have the definition already stated for the formula (VI). N-(2-Hydroxyethyl)oxazolidines of the formula (VII) are obtainable in turn, for example, through the reaction of diethanolamine with a ketone or aldehyde, with elimination of water.

One example of a commercially available polyoxazolidine is the curative Harter OZ (from Bayer).

Polyenamines suitable as latent polyamines LA are obtainable, for example, through the reaction of polyamines containing at least two secondary amino groups with aliphatic or cycloaliphatic aldehydes or ketones which have at least one C—H moiety positioned a to the carbonyl group, with elimination of water.

Examples of polyamines suitable for this reaction and having at least two secondary amino groups are piperazine, 4,4,-dipiperidylpropane, N,N′-dimethylhexamethylenediamine, and homologues with higher alkyl or cycloalkyl groups instead of the methyl groups, and also further polyamines having two secondary amino groups, of the kind used for two-component polyurethanes, for example.

Examples of suitable aldehydes which have at least one C—H moiety positioned a to the carbonyl group include propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexanecarboxaldehyde, and diphenylacetaldehyde.

Suitable ketones are more particularly cyclic ketones, examples being cyclopentanone and cyclohexanone and also their derivatives.

Additionally suitable as latent polyamines LA are polyketimines and polyaldimines. Suitable polyketimines or polyaldimines are obtainable in a first embodiment through the reaction of polyamines PA having aliphatic primary amino groups with ketones or aldehydes by known methods, with elimination of water.

Examples of suitable polyamines PA having aliphatic primary amino groups are as follows: aliphatic polyamines such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexamethylenediamine, 2,2,4- and 2,4,4-trimethylhexamethylenediamine and mixtures thereof, 1,7-heptanediamine, 1,8-octanediamine, 4-aminomethyl-1,8-octanediamine, 1,9-nonanediamine, 1,10-decanediamine, 1,11-undecanediamine, 1,12-dodecanediamine, methylbis(3-aminopropyl)amine, 1,5-diamino-2-methylpentane (MPMD), 1,3-diaminopentane (DAMP), 2,5-dimethyl-1,6-hexamethylenediamine, cycloaliphatic polyamines such as 1,3- and 1,4-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)-methane, 1-amino-3-aminomethyl-3,5,5-trimethylcyclohexane (i.e., isophoronediamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo-[2.2.1]heptane (NBDA, produced by Mitsui Chemicals), 3(4),8(9)-bis(aminomethyl)tricyclo[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane, 1,3- and 1,4-xylylenediamine, aliphatic polyamines containing ether groups, such as bis(2-aminoethyl)ether, 4,7-dioxadecane-1,10-diamine, 4,9-dioxadodecane-1,12-diamine, and higher oligomers thereof, polyoxyalkylene-polyamines having theoretically two or three amino groups, obtainable for example under the name Jeffamine® (from Huntsman Chemicals), under the name Polyetheramin (from BASF), or under the name PC Amine® (from Nitroil), and also mixtures of the aforementioned polyamines.

Preferred polyamines PA are 1,6-hexamethylenediamine, MPMD, DAMP, IPDA, 4-aminomethyl-1,8-octanediamine, 1,3-xylylenediamine, 1,3-bis(aminomethyl)cyclohexane, bis(4-aminocyclohexyl)methane, bis(4-amino-3-methylcyclohexyl)methane, 3(4),8(9)-bis(aminomethyl)tricyclo[5.2.1.0^{2,6}]decane, 1,4-diamino-2,2,6-trimethylcyclohexane, polyoxyalkylene-polyamines having theoretically two or three amino groups such as the products EDR-148, D-230, D-400, D-2000, D-403, and T-5000, obtainable under the trade name Jeffamine® from Huntsman, and analogous compounds from BASF or Nitroil, and also, more particularly, mixtures of two or more of the aforementioned polyamines.

In a second embodiment, suitable latent polyamines LA are polyketimines and polyaldimines obtainable starting from an amine C which as well as one or two aliphatic primary amino groups also has a further reactive group which contains an active hydrogen. In the present document the term “active hydrogen” identifies a deprotonable hydrogen atom which is attached to a nitrogen, oxygen or sulfur atom. An amine C of this kind is converted using ketones or aldehydes and known methods, with elimination of water, into a ketimine or aldimine containing an active hydrogen, and this ketimine or aldimine is subsequently converted, through the reaction with, for example, a polyisocyanate, into corresponding polyketimines or polyaldimines.

Suitable amines C are compounds of the formula (III)

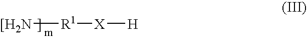

where
m stands for 1 or 2, preferably for 1,
R¹ stands for an (m+1)-valent hydrocarbon radical having 2 to 12 C atoms which optionally contains at least one heteroatom, more particularly in the form of ether oxygen or tertiary amine nitrogen, and
X stands for O, S or N—R⁶, where R⁶ either (i) stands for a monovalent hydrocarbon radical having 1 to 20 C atoms which optionally contains at least one carbonate, nitrile, nitro, phosphonate, sulfone or sulfonate group, or (ii) stands for —R⁷—NH₂, where R⁷ stands for a divalent hydrocarbon radical which optionally contains heteroatoms, more particularly in the form of ether oxygen or tertiary amine nitrogen.

Suitability as amine C is possessed, for example, by the compounds identified below:
aliphatic hydroxyamines such as 5-amino-1-pentanol, 6-amino-1-hexanol, 7-amino-1-heptanol, 8-amino-1-octanol, 10-amino-1-decanol, 12-amino-1-dodecanol;
aliphatic mercaptoamines such as 6-amino-1-hexanethiol, 8-amino-1-octanethiol, 10-amino-1-decanethiol, 12-amino-1-dodecanethiol;
dihydric or higher polyhydric aliphatic amines which besides one or two primary amino groups carry a secondary amino group, such as N-methyl-1,2-ethanediamine, N-ethyl-1,2-ethanediamine, N-cyclohexyl-1,2-ethanediamine, N-methyl-1,3-propanediamine, N-ethyl-1,3-propanediamine, N-butyl-1,3-propanediamine, N-cyclohexyl-1,3-propanediamine, 4-aminomethylpiperidine, 3-(4-aminobutyl)piperidine, diethylenetriamine (DETA), dipropylenetriamine (DPTA), bishexamethylenetriamine (BHMT) and fatty diamines such as N-cocoalkyl-1,3-propanediamine, N-oleyl-1,3-propanediamine, N-soyaalkyl-1,3-propanediamine, and N-tallowalkyl-1,3-propanediamine.

Polyketamines suitable as latent polyamines LA are obtainable, for example, through the reaction of at least one polyamine PA with at least one ketone, with elimination of water, or through reaction of at least one amine C with at least one ketone, with elimination of water, and subsequent reaction of the resulting ketimine with, for example, a polyisocyanate.

Examples of ketones suitable for these reactions are acetone, methyl ethyl ketone, methyl propyl ketone, methyl isopropyl ketone, methyl isobutyl ketone, methyl pentyl ketone, methyl isopentyl ketone, diethyl ketone, dipropyl ketone, diisopropyl ketone, dibutyl ketone, diisobutyl ketone, cyclopentanone, cyclohexanone, acetylacetone, and acetophenone.

Of further suitability as latent polyamines LA are compounds which have a combination of two or three blocked amino groups selected from the group encompassing oxazolidino, enamino, ketimino, and aldimino groups, at least two of these blocked amino groups being different from one another, in other words, for example, oxazolidine-aldimines, ketimineenamines or aldimine-enamines. The oxazolidino, enamino, ketimino, and aldimino groups of these compounds correspond to those in the above-described polyoxazolidines, polyenamines, polyketimines, and polyaldimines.

Preferred latent polyamines LA are polyaldimines.

Suitable polyaldimines are obtainable in a first embodiment through the reaction of at least one polyamine PA with at least one aldehyde.

In a second embodiment, suitable polyaldimines are obtainable through the reaction of an amine C of the formula (III) with at least one aldehyde and subsequent reaction of the resulting aldimine with a polyisocyanate.

It is also possible to use dialdehydes for preparing polyaldimines, in which case oligomeric products are formed.

Examples of aldehydes suitable for these reactions include propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexanecarboxaldehyde, and diphenylacetaldehyde, and also the aldehydes ALD set out below.

Preferred aldehydes for these reactions are aldehydes ALD. A feature of these aldehydes is that they do not have a C—H moiety positioned α to the carbonyl group and, consequently, are not enolizable. Polyaldimines derived from aldehydes ALD have the property of not forming tautomeric enamines, since they contain no hydrogen as substituent positioned α to the C atom of the aldimino group. Together with polyurethane polymers P containing isocyanate groups, such polyaldimines form mixtures of particularly good storability, more particularly even when the polyurethane polymer P has highly reactive aromatic isocyanate groups, such as those of TDI and MDI.

Suitable aldehydes ALD are compounds of the formulae (I) and (II)

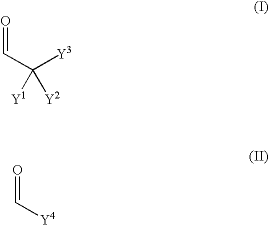

where
Y and Y² either independently of one another each stand for a monovalent hydrocarbon radical having 1 to 12 C atoms, or together form a divalent hydrocarbon radical having 4 to 20 C atoms which is part of an optionally substituted carbocyclic ring having 5 to 8, preferably 6, C atoms, and
Y³ stands for a monovalent hydrocarbon radical which optionally contains at least one heteroatom, more particularly oxygen in the form of ether, carbonyl or ester groups, and
Y⁴ either stands for a substituted or unsubstituted aryl or heteroaryl group which has a ring size of between 5 and 8, preferably 6, atoms; or stands for

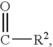

where R² stands for a hydrogen atom or for an alkoxy group;
or stands for a substituted or unsubstituted alkenyl or arylalkenyl group having at least 6 C atoms.

The property of the aldehydes ALD of the formula (I) and (II) is that their radicals Y¹, Y², Y³, and Y⁴ do not have any moieties which are reactive with isocyanate groups in the absence of water; more particularly, Y¹, Y², Y³, and Y⁴ have no hydroxyl groups, secondary amino groups, urea groups or other groups containing active hydrogen.

Examples of suitable aldehydes ALD of the formula (I) are 2,2-dimethylpropanal, 2,2-dimethylbutanal, 2,2-diethylbutanal, 1-methylcyclopentanecarboxaldehyde, 1-methylcyclohexanecarboxaldehyde; ethers formed from 2-hydroxy-2-methylpropanal and alcohols such as propanol, isopropanol, butanol, and 2-ethylhexanol; esters formed from 2-formyl-2-methylpropionic acid or 3-formyl-3-methylbutyric acid and alcohols such as propanol, isopropanol, butanol, and 2-ethylhexanol; esters formed from 2-hydroxy-2-methylpropanal and carboxylic acids such as butyric acid, isobutyric acid, and 2-ethylhexanoic acid; and also the ethers and esters—described below as being particularly suitable—of 2,2-disubstituted 3-hydroxypropanals, -butanals or analogous higher aldehydes, more particularly of 2,2-dimethyl-3-hydroxypropanal.

Aldehydes ALD of the formula (I) that are suitable more particularly are compounds of the formula (Ia)

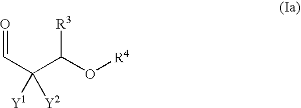

where R³ stands for a hydrogen atom or for an alkyl or arylalkyl group and R⁴ stands for an alkyl or arylalkyl group, and Y¹ and Y² have the definitions already stated.

Compounds of the formula (Ia) represent ethers of aliphatic, araliphatic or alicyclic 2,2-disubstituted 3-hydroxyaldehydes, of the kind formed from aldol reactions, more particularly crossed aldol reactions, between primary or secondary aliphatic aldehydes, more particularly formaldehyde, and secondary aliphatic, secondary araliphatic or secondary alicyclic aldehydes, such as, for example, 2-methylbutyraldehyde, 2-ethylbutyraldehyde, 2-methylvaleraldehyde, 2-ethylcaproaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde (hydrotrope aldehyde) or diphenylacetaldehyde, with alcohols, such as, for example, methanol, ethanol, propanol, isopropanol, butanol, 2-ethylhexanol or fatty alcohols. Examples of compounds of the formula (Ia) are 2,2-dimethyl-3-methoxypropanal, 2,2-dimethyl-3-ethoxypropanal, 2,2-dimethyl-3-isopropoxypropanal, 2,2-dimethyl-3-butoxypropanal, and 2,2-dimethyl-3-(2-ethylhexyloxy)propanal.

Further aldehydes ALD of the formula (I) that are suitable more particularly are compounds of the formula (Ib)

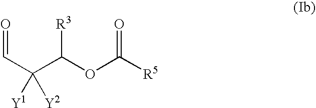

where
R³ again stands for a hydrogen atom or for an alkyl or aralkyl group,
R⁵ stands for a hydrogen atom or an alkyl or aralkyl or aryl group, optionally having at least one heteroatom, more particularly having at least one ether oxygen, and optionally with at least one carboxyl group, and optionally with at least one ester group, or a singly or multiply unsaturated linear or branched hydrocarbon chain,
and Y¹ and Y² have the definitions already stated.

Compounds of the formula (Ib) represent esters of the above-described 2,2-disubstituted 3-hydroxyaldehydes, such as, for example, 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal, with aliphatic or aromatic carboxylic acids, such as, for example, formic acid, acetic acid, propionic acid, butyric acid, isobutyric acid, valeric acid, caproic acid, 2-ethylcaproic acid, capric acid, lauric acid, myristic acid, palmitic acid, stearic acid, and benzoic acid.

Preferred compounds of the formula (Ib) are esters of 2,2-dimethyl-3-hydroxypropanal and the stated carboxylic acids, such as, for example, 2,2-dimethyl-3-formyloxypropanal, 2,2-dimethyl-3-acetoxypropanal, 2,2-dimethyl-3-isobutyroxypropanal, 2,2-dimethyl-3-(2-ethylhexanoyloxy)propanal, 2,2-dimethyl-3-lauroyloxypropanal, 2,2-dimethyl-3-palmitoyloxypropanal, 2,2-dimethyl-3-stearoyloxypropanal and 2,2-dimethyl-3-benzoyloxypropanal, and also analogous esters of other 2,2-disubstituted 3-hydroxyaldehydes.

In one preferred preparation method of an aldehyde ALD of the formula (Ib) a 2,2-disubstituted 3-hydroxyaldehyde, an example being 2,2-dimethyl-3-hydroxypropanal, which is preparable, for example, from formaldehyde (or paraformaldehyde) and isobutyraldehyde, where appropriate in situ, is reacted with a carboxylic acid to form the corresponding ester. This esterification can take place without the use of solvents by known methods, as described for example in Houben-Weyl, “Methoden der organischen Chemie”, Vol. VIII, pages 516-528.

It is also possible to prepare aldehydes ALD of the formula (Ib) by carrying out the esterification of a 2,2-disubstituted 3-hydroxyaldehyde using an aliphatic or cycloaliphatic dicarboxylic acid, such as succinic acid, adipic acid or sebacic acid, for example. In this way, corresponding tertiary aliphatic or tertiary cycloaliphatic dialdehdyes are obtained.

In one particularly preferred embodiment the aldehydes ALD of the formula (I) are odorless. By an “odorless” substance is meant a substance which is so low in odor that for the majority of human individuals it cannot be smelled, in other words cannot be perceived with the nose.

Odorless aldehydes ALD of the formula (I) are, more particularly, aldehydes ALD of the formula (Ib), in which the radical R⁵ either stands for a linear or branched alkyl chain having 11 to 30 carbon atoms, optionally with at least one heteroatom, more particularly with at least one ether oxygen, or stands for a singly or multiply unsaturated linear or branched hydrocarbon chain having 11 to 30 carbon atoms.

Examples of odorless aldehydes ALD of the formula (Ib) are esterification products formed from the aforementioned 2,2-disubstituted 3-hydroxyaldehydes with carboxylic acids such as, for example, lauric acid, tridecanoic acid, myristic acid, pentadecanoic acid, palmitic acid, margaric acid, stearic acid, nonadecanoic acid, arachidic acid, palmitoleic acid, oleic acid, erucic acid, linoleic acid, linolenic acid, elaeostearic acid, arachidonic acid, fatty acids from the industrial hydrolysis of natural oils and fats, such as rapeseed oil, sunflower oil, linseed oil, olive oil, coconut oil, oil palm kernel oil and oil palm oil, for example, and also industrial mixtures of fatty acids that comprise these acids. Preferred aldehydes of the formula (Ib) are 2,2-dimethyl-3-lauroyloxypropanal, 2,2-dimethyl-3-myristoyloxypropanal, 2,2-dimethyl-3-palmitoyloxypropanal, and 2,2-dimethyl-3-stearoyloxypropanal. Particular preference is given to 2,2-dimethyl-3-lauroyloxypropanal.

Examples of suitable aldehydes ALD of the formula (II) include benzaldehyde, 2- and 3- and 4-tolualdehyde, 4-ethyl- and 4-propyl- and 4-isopropyl- and 4-butylbenzaldehyde, 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, 2-, 3- and 4-nitrobenzaldehyde, 2- and 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and its 3-, 4-, 5-, 6-, 7-, and 8-position isomers, and also anthracene-9-carbaldehyde, 10-methylanthracene-9-carbaldehyde, 9-ethyl-3-carbazolecarbaldehyde, pyrenecarbaldehyde, nicotinaldehyde, terephthalaldehyde and isophthalaldehyde.

Suitable aldehydes ALD of the formula (II) are, furthermore, glyoxal, glyoxalic esters, such as methyl glyoxalate, for example, and cinnamaldehyde and substituted cinnamaldehydes.

As already mentioned, the latent polyamines LA in the first component A of the two-component composition preferably represent polyaldimines. The particularly preferred polyaldimines, which are obtainable starting from aldehydes ALD of the formula (I) and (II), are compounds of the formula (IV) or (V),

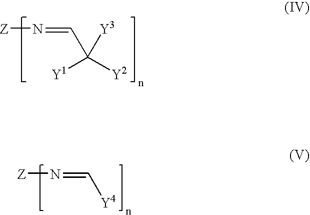

where Y¹, Y², Y³, and Y⁴ have the definitions already described for the formulae (I) and (II),
n stands for 2 or 3, and
Z stands for the radical of a polyamine following removal of n primary aliphatic amino groups.

Z may either (i) stand for the radical of a polyamine PA following removal of n primary aliphatic amino groups, or (ii) stand for the radical of a hypothetical direct reaction product of at least one polyisocyanate and at least one amine C following removal of n primary aliphatic amino groups.

Typically there is sufficient latent polyamine LA in component A of the two-component composition for the number of blocked amino groups to be less than or, at the most, the same as the number of isocyanate groups. More particularly the ratio between the number of the blocked amino groups and the number of the isocyanate groups is situated in the range from 0.1 to 1.0, preferably 0.3 to 0.9, more preferably 0.4 to 0.8.

As well as component A, the two-component composition is composed of a second component B comprising at least one acid K and water.

The acid K is any desired Brønsted acid, such as, for example, hydrochloric acid, sulfuric acid, sulfurous acid, amidosulfuric acid, phosphoric acid, mono- and di-alkyl and -aryl phosphates such as tridecyl phosphate, dibutyl phosphate, diphenyl phosphate, and bis(2-ethylhexyl)phosphate, phosphorous acid, nitric acid, nitrous acid, perchloric acid, chlorous acid, boric acid, and also any desired organic Brønsted acids, and also mixtures of the aforementioned Brønsted acids.

Preference as acid K is given to organic Brønsted acids such as, for example
carboxylic acids, examples being saturated aliphatic monocarboxylic acids such as formic acid, acetic acid, propionic acid, butyric acid, isobutyric acid, valeric acid, isovaleric acid, pivalic acid, caproic acid, enanthic acid, caprylic acid, 2-ethylhexanoic acid, pelargonic acid, capric acid, neodecanoic acid, undecanoic acid, lauric acid, tridecanoic acid, myristic acid, pentadecanoic acid, palmitic acid, margaric acid, stearic acid, isostearic acid, arachidic acid, behenic acid; saturated aliphatic polycarboxylic acids such as oxalic acid, malonic acid, succinic acid, butaric acid, adipic acid, pimelic acid, suberic acid, azaleic acid, sebacic acid, dodecanedioic acid; singly or multiply unsaturated aliphatic monocarboxylic and polycarboxylic acids such as palmitoleic acid, oleic acid, erucic acid, sorbic acid, linoleic acid, linolenic acid, elaeosteric acid, ricinoleic acid, ricinenic acid, maleic acid, fumaric acid, sorbic acid; cycloaliphatic monocarboxylic and polycarboxylic acids such as cyclohexanecarboxylic acid, hexahydrophthalic acid, tetrahydrophthalic acid, resin acids, naphthenic acids; aliphatic hydroxycarboxylic acids such as glycolic acid, lactic acid, mandelic acid, hydroxybutyric acid, tartaric acid, malic acid, citric acid; hydrogenated aliphatic carboxylic acids such as trichloroacetic acid or 2-chloropropionic acid; aromatic monocarboxylic and polycarboxylic acids such as benzoic acid, salicyclic acid, gallic acid, the positionally isomeric tolylic acids, methoxybenzoic acids, chlorobenzoic acids, nitrobenzoic acids, phthalic acid, terephthalic acid, isophthalic acid; technical carboxylic acid mixtures such as Versatic acids, for example; polycarboxylic acids from the polymerization or copolymerization of acrylic and methacrylic acid;
sulfonic acids such as methylsulfonic acid, vinylsulfonic acid, butylsulphonic acid, 3-hydroxypropylsulfonic acid, sulfoacetic acid, benzenesulfonic acid, p-toluenesulfonic acid, p-xylenesulfonic acid, 4-dodecylbenzenesulfonic acid, 1-naphthalenesulfonic acid, dinonylnaphthalenesulfonic acid, and dinonylnaphthalenedisulfonic acid;
organic phosphonic acids and monoalkylphosphonates such as methylphosphonic acid, vinylphosphonic acid, butylphosphonic acid, 2-hydroxyethylphosphonic acid, phenylphosphonic acid, tolylphosphonic acid, xylylphosphonic acid, phosphonoacetic acid, etidronic acid, ethyl methylphosphonate;
   and also mixtures of the aforementioned Brønsted acids.

Preferred acids K are organic Brønsted acids in the form of carboxylic acids and sulfonic acids, more particularly aromatic carboxylic acids such as benzoic acid and salicylic acid. Particular preference is given to salicylic acid.

The acid K has a catalytic action on the hydrolysis of the latent polyamine LA of component A. As a result it has the effect, depending on concentration and acid strength, of a more or less sharp acceleration of the curing of the two-component composition.

Typically the acid K is present in component B in an amount of 0.1% to 10% by weight, based on component B. Preference is given to an amount of the acid K of 0.3% to 5% by weight, based on component B.

Component B further comprises water.

The water may either be present in free form or may be bound to a carrier material. The binding to any carrier material present is reversible; in other words, the water is available for the reaction with the latent polyamine LA of first component A.

Suitable carrier materials for component B are porous materials which include water in cavities. These are, more particularly, special silicates and zeolites. Particularly suitable are kieselguhr and molecular sieves. The size of the cavities in this case should be chosen such that they are optimal for the accommodation of water. Accordingly molecular sieves with a pore size of 4 Å are found particularly apt.

Further suitable carrier materials are those which accommodate water in nonstoichiometric quantities and have a pasty consistency or form gels. Such carrier materials may be organic or inorganic. Examples thereof are silica gels, clays, such as montmorillonites, bentonites, hectorites or polysaccharides, such as cellulose and starch, or polyacrylic acids, which are also known as “superabsorbents” and are employed, for example, in the manufacture of hygiene articles. Additionally suitable are carrier materials which carry ionic groups, such as polyurethane polymers with carboxyl groups or sulfonic acid groups as sidechains, for example, and their salts.

Additionally suitable forms of water bound to a carrier material are, for example, hydrates and aqua complexes, more particularly inorganic compounds which contain water in coordinatively bound form or as water of crystallization. Examples of hydrates are Na₂SO₄.10H₂O, CaSO₄.2H₂O, CaSO₄.½H₂O, Na₂B₄O₇.10H₂O, MgSO₄.7H₂O. Examples of aqua complexes are the hexaqua complexes of iron(II), iron(III), cobalt(II), cobalt(III) and nickel(II), and also mixed complexes such as [(H₂O)₄Co(NH₃)₂]³⁺ or [Cl(H₂O)₃CO(NH₃)₂]²⁺.

The mixing of the two components A and B leads to the largely direct availability of water in the overall two-component composition, as a result of which said composition cures much more quickly than a one-component polyurethane composition, in which water is available exclusively by diffusion of atmospheric moisture from the outside to the inside.

The amount of water contained within component B is suitably matched to the amount of water needed in order to fully cure component A. The amount of water needed to fully cure component A, in mol, is calculated in accordance with the following formula: (equivalent of blocked amino groups)+½ (equivalent of isocyanate groups—equivalent of blocked amino groups).

The amount of water contained within component B is chosen such that the ratio of the amount of water introduced by component B to the amount of water needed for the full curing of component A has a value of 0.5 to 10, preferably 1 to 7.5, more preferably 1.5 to 5.

It is likewise preferred for component B to contain water in an amount which is at least stoichiometric in relation to the blocked amino groups.

The functioning of the system is not very dependent on the observance of a defined mixing ratio between the two components A and B, as is the case in a conventional two-component polyurethane system. A superstoichiometric amount of water in relation to the blocked amino groups does not disrupt the curing of the composition, since the maximum amount of amino groups which can be released by hydrolysis and react with the isocyanate groups of component A is fixed by the latent polyamine LA present in component A. Water present in excess after the hydrolysis of the blocked amino groups can react with any isocyanate groups still present in the polyurethane polymer P, or can remain in the cured composition and diffuse out or evaporate therefrom.

A substoichiometric amount of water in relation to the blocked amino groups likewise does not disrupt the curing of the composition, since water lacking for the complete curing of the composition can be compensated by atmospheric moisture.

In addition to at least one polyurethane polymer P and at least one latent polyamine LA in component A and to at least one acid K and water in component B, the two-component composition described may comprise further adjuvants. Among others, the following auxiliaries and additives may be present, it being clear to a skilled worker whether they are suitable for both or for just one of the two components A and B:
plasticizers, examples being carboxylic esters such as phthalates, dioctyl phthalate, diisononyl phthalate or diisodecyl phthalate for example, adipates, dioctyl adipate for example, azelates and sebacates, polyols, examples being polyoxyalkylenepolyols or polyesterpolyols, organic phosphoric and sulfonic esters or polybutenes;
solvents;
organic and inorganic fillers, such as ground or precipitated calcium carbonates, for example, which where appropriate are coated with stearates, or carbon blacks, more particularly industrially manufactured carbon blacks (referred to below as “carbon black”), kaolins, aluminum oxides, silicas, more particularly highly disperse silicas from pyrolysis processes, PVC powders or hollow beads;
fibers, of polyethylene for example;
pigments, titanium dioxide or iron oxides for example;
catalysts which accelerate the hydrolysis of the latent polyamines, such as, for example, the aforementioned acids K, and also their anhydrides or silyl esters;
catalysts which accelerate the reaction of the isocyanate groups with water, examples being organotin compounds such as dibutyltin diacetate, dibutyltin dilaurate, dibutyltin dichloride, dibutyltin diacetylacetonate, and dioctyltin dilaurate, bismuth compounds such as bismuth trioctoate and bismuth tris(neodecanoate), and compounds containing tertiary amino groups, such as 2,2′-dimorpholinodiethyl ether and 1,4-diazabicyclo[2.2.2]octane;
rheology modifiers such as thickeners, for example, examples being urea compounds, polyamide waxes, bentonites or fumed silicas;

reactive diluents and crosslinkers, examples being monomeric polyisocyanates such as MDI, PMDI, TDI, HDI, 1,12-dodecamethylene diisocyanate, cyclohexane 1,3- or 1,4-diisocyanate, IPDI, perhydro-2,4′- and -4,4′-diphenylmethane diisocyanate, 1,3- and 1,4-tetramethylxylylene diisocyanate and also oligomers of these polyisocyanates, more particularly in the form of isocyanurates, carbodiimides, uretonimines, biurets, allophanates or iminooxadiazinediones, adducts of monomeric polyisocyanates with short-chain polyols, and also adipic dihydrazide and other dihydrazides;
dryers, such as molecular sieves, calcium oxide, highly reactive isocyanates such as p-tosyl isocyanate, orthoformic esters, alkoxysilanes such as tetraethoxysilane, organoalkoxysilanes such as vinyltrimethoxysilane, and organoalkoxysilanes which have a functional group positioned a to the silane group;
adhesion promoters, more particularly organoalkoxysilanes such as, for example, epoxysilanes, vinylsilanes, (meth)acrylosilanes, isocyanatosilanes, carbamatosilanes, S-(alkylcarbonyl)-mercaptosilanes, and aldiminosilanes, and also oligomeric forms of these silanes;
stabilizers against heat, light and UV radiation;
flame retardants;
surface-active substances such as wetting agents, flow control agents, deaerating agents or defoamers, for example;
biocides such as algicides, fungicides or fungal growth inhibitor substances, for example.

It is advantageous to ensure that adjuvants which are used as part of component A do not adversely affect the storage stability of component A. In other words, during storage, these adjuvants must not significantly initiate the reactions that lead to crosslinking, such as the hydrolysis of the blocked amino groups or crosslinking of the isocyanate groups. In particular this means that all of these adjuvants should contain no water, or traces of water at most. It can be sensible to carry out chemical or physical drying of certain adjuvants prior to their incorporation into component A.

In addition to at least one polyurethane polymer P and at least one latent polyamine LA, component A preferably comprises plasticizers, fillers, and catalysts.

Preferred fillers for component A are carbon black, calcium carbonates, calcined kaolins, highly disperse silicas from pyrolysis processes, and combinations of these fillers.

A preferred catalyst in component A is a catalyst for the hydrolysis of the latent polyamines LA, more particularly an acid K, or a catalyst which accelerates the reaction of the isocyanate groups with water, more particularly organotin compounds such as dibutyltin dilaurate, or a mixture of an acid K and a further catalyst that accelerates the reaction of the isocyanate groups with water.

Preferably, in addition to at least one acid K and water, component B comprises a filler, or a plasticizer, or a filler and a plasticizer.

Component B is intended sharply to accelerate the curing of component A, which can also be cured by means of atmospheric moisture alone. However, it is intended not to alter substantially, by its presence, the mechanical properties, such as tensile strength, tensile shear strength, and elongation at break, of the component A cured by means of atmospheric moisture alone. This means, more particularly, that component B contains no polyamines which contain primary or secondary amino groups in free or blocked form, in other words, for example, no latent polyamines LA, and, more particularly, preferably no polyaldimines.

It is preferred for the two-component composition described to contain an acid K both in component A and in component B.

As already mentioned, component A of the two-component composition is intended to cure with atmospheric moisture alone as well. Component A is preferably formulated such that it can also be used as a one-component polyurethane composition curing by means of atmospheric moisture, more particularly as an elastic adhesive or sealant. For this purpose it is advantageous to catalyze component A with an acid K so that a cure rate is attained that is suitable for one-component application, as, for example, to a skinover time in the range from 20 minutes to 2 hours.

Catalyzing component A by an acid K, however, is not enough to achieve the high early strength at an early point in time that is desired in certain applications and to do so in two-component application together with a second component that contains water bound to a carrier material but no acid K, as described in WO 03/059978A1. It is true that a high early strength could be achieved by means of a significantly higher level of acid K in component A; however, component A would thereby lose the property of being able to be employed in one-component form as well, since its skinover time would in that case be unallowably short. Furthermore, in the case of a very high acid K content, it is likely that the storage stability of component A would be significantly reduced.

The above-described two-component application of component A with a second component B which as well as water includes an acid K gets around this difficulty in an elegant way. Hence it is possible to use a storage-stable component A, which can also be employed in one-component form, for adhesive applications which impose exacting requirements on the early strength; the cure rate of the two-component system can in this case be adjusted to the requirements of the particular application, either by way of the amount of acid K in component B or by way of the amount of component B which is mixed to component A. The great flexibility in the application of the universal component A is of great advantage for the commercial utilization of two-component compositions of this kind.

Component A is prepared in the absence of moisture. Separately from one another, the two components A and B are storage-stable; that is, in a suitable pack or arrangement, such as in a drum, a pouch or a cartridge, for example, they can be stored for a time of several months up to a year or more, prior to their application, without undergoing any service-relevant change in their respective properties.

Typically the storage stability of component A is determined via the measurement of the viscosity or the extrusion force.

In one embodiment, component B may be stored in a container, as described later on below, which is integrated in a metering attachment.

It is also possible for the two components to be dispensed into containers that are separated from one another by dividing walls and to be stored therein. Examples of such containers are coaxial cartridges or twin cartridges.

For industrial applications with relatively large quantities it is typical to store the two components separately, each in a moisture tight container, such as a drum or a hobbock, for example.

A suitable mixing ratio of the two components A and B depends substantially on the respective composition of the two components. Component A also cures with atmospheric moisture alone. The second component, component B, leads to a sharp acceleration in the cure rate of the composition, without substantially affecting the mechanical properties of the cured composition. As a result, of course, the mixing ratio of the two components A and B is to be chosen such that component A is present in a substantially greater amount than component B in the composition. Preference is given to a mixing ratio in the range of 100 parts by weight of component A to 0.5-10 parts by weight of component B.

The mixing of the two components A and B is advantageously accomplished continuously during the application.

In a first embodiment the mixing of the two components A and B takes place by means of a metering attachment containing two interengaging metering rotors. Metering attachments of this kind are described for example in patent EP 0 749 530 B1. The metering attachment, for relatively small applications, is preferably mounted onto a commercially customary cartridge, containing component A, while component B is located in a container which is integrated in the metering attachment. Metering and mixing take place at the time of application within this metering attachment, which is operated passively by the application of pressure to the cartridge, by means for example of a customary commercial cartridge press. For improved mixing it is additionally possible to mount a static mixer on the exit aperture of this metering attachment.

In a second embodiment the two components A and B are conveyed from drums or hobbocks. In this case the two components A and B are mixed advantageously in a metering attachment, the mixing operation being static or dynamic.

In one preferred embodiment the mixing of the two components A and B of the composition takes place substantially homogeneously.

In a typical application of the two-component composition, the two components A and B of the composition are first mixed as described and then the mixed composition, typically in the form of a bead, is contacted with at least one solid surface and cured.

When the two components A and B are mixed, the polyurethane polymer P containing isocyanate groups and the latent polyamine LA come into contact with water. The blocked amino groups of the latent polyamine LA have the property of undergoing hydrolysis on contact with moisture. The isocyanate groups that are present in the composition react with the polyamine that is liberated formally, and a compound used for the blocking of the amino groups, in the form of a ketone or aldehyde, is released. Excess isocyanate groups, in other words those which do not react with blocked amino groups, react directly with water and so form, among other species, urea groups. As a result of these reactions, the composition cures; this process is also referred to as crosslinking. The reaction of the isocyanate groups on the hydrolyzing latent polyamine LA need not necessarily take place by way of free amino groups, but may instead proceed via intermediates of the hydrolysis as well. It is conceivable, for example, for former aldimino or ketimino groups of the hydrolyzing latent polyamine LA to react in the form of hemiaminal groups with the isocyanate groups.

If additional water is needed for the complete curing of the composition, it may penetrate, following application of the composition, the applied composition from the ambient environment, more particularly in the form of atmospheric moisture.

The two-component composition described cures very rapidly after the two components A and B have been mixed. It very rapidly possesses a high early strength. In the cured state it possesses elastic properties, in other words a high mechanical strength in combination with high extensibility, and also possesses good adhesion properties. This makes it suitable for a multiplicity of applications, more particularly as an elastic adhesive, an elastic sealant or an elastic coating. It is suitable more particularly for applications which require a high early strength very rapidly.

Where, as the composition cures, only the odorless aldehydes ALD described above are released, the curing of the composition does not give rise to any disruptive odor, which is a great advantage, or even a prerequisite, for numerous applications, more particularly in enclosed spaces.

Examples of suitable applications include the adhesive bonding of components in construction or civil engineering and in the manufacture or repair of industrial goods or consumer goods, more particularly of windows, household appliances or means of transport, such as water vehicles or land vehicles, preferably automobiles, buses, trucks, trains or ships; the sealing of joints, seams or cavities in industrial manufacture or repair, or in construction or civil engineering; and the coating of various substrates, in the form for example of a paint, varnish, primer, sealant or protective coating, or as a floor covering, for offices, living areas, hospitals, schools, warehouses, and vehicle parking facilities, for example.

The particularly preferred embodiment which cures without odor is especially suitable for applications in enclosed spaces, such as the sealing of joints inside buildings or the bonding of components in the interior of vehicles, for example. There is a particular desire here for the odorless quality, not least during and shortly after the application of the adhesive or sealant.

In one preferred embodiment the composition described is used as an elastic adhesive or sealant.

In its application as an adhesive, the composition is applied to a substrate S1 and/or a substrate S2. The adhesive may therefore be applied to one substrate or the other or to both substrates. Thereafter the parts to be bonded are joined, whereupon the adhesive cures. Here it should be ensured that the joining of the parts takes place within the time known as the open time, in order to ensure that both adherends are reliably bonded to one another.

In the application as a sealant, the composition is applied between the substrates S1 and S2, and curing takes place subsequently. Typically the sealant is injected into a joint.

In both applications the substrate S1 may be the same as or different than substrate S2.

Examples of suitable substrates S1 or S2 are inorganic substrates such as glass, glass ceramic, concrete, mortar, brick, tile, plaster, and natural stones such as granite or marble; metals or alloys such as aluminum, steel, nonferrous metals, galvanized metals; organic substrates such as wood, plastics such as PVC, polycarbonates, PMMA, polyethylene, polypropylene, polyesters, epoxy resins; coated substrates such as powder-coated metals or alloys; and also paints and finishes, more particularly automotive topcoats.

If necessary the substrates can be pretreated prior to the application of the adhesive or sealant. Pretreatments of this kind include, more particularly, physical and/or chemical cleaning techniques, examples being abrading, sandblasting, brushing or the like, or treatment with cleaners or solvents; or the application of an adhesion promoter, an adhesion promoter solution or a primer; or flame or plasma treatment, more particularly an air plasma pretreatment at atmospheric ambient pressure.

After the substrates S1 and S2 have been bonded or sealed by means of the composition described, a bonded or sealed article is obtained. An article of this kind may be a built structure, more particularly a built structure in construction or civil engineering, or it may be an industrial product or a consumer product such as a window, a household appliance or a means of transport, for example, such as a water or land vehicle, for example, more particularly an automobile, a bus, a truck, a train or a ship, or a component for installation thereof.

For application of the composition as a sealant for joints, for example, in construction or civil engineering, or for application as an adhesive for elastic bonds, such as in vehicle construction, for example, the composition preferably has a pasty consistency with properties of structural viscosity. A pasty sealant or adhesive of this kind is applied to the substrate by means of a suitable apparatus. Suitable methods of application are, for example, application from commercially customary cartridges, which are operated manually or by means of compressed air, or from a drum or hobbock by means of a conveying pump or an extruder, where appropriate by means of an application robot.

A sealant or adhesive preferably has a high firmness of consistency and short stringing. That is, it remains in the applied form following application, in other words does not run apart, and, after the application device has been set down, the adhesive or sealant forms very short strings, or none at all, so that the substrate and the application device are as far as possible not fouled.

An adhesive for elastic bonds, in vehicle construction, for example, is applied preferably in the form of a bead having a substantially circular or triangular cross-sectional area.

Elastic bonds in vehicle construction, for example, are the adhesive attachment of parts, such as plastic covers, trim strips, flanges, bumpers, driver's cabs or other components for installation, to the painted bodywork of a means of transport, or the adhesive installation of glazing into the body. Examples of vehicles include automobiles, trucks, buses, rail vehicles, and ships.

The composition of the invention may be applied at room temperature or below. An alternative possibility is to heat component A and/or component B to an elevated temperature prior to mixing, in order for example to achieve an even quicker cure rate, or in order to facilitate the conveying or metering or mixing of the components.

The two-component composition described, composed of
a) a first component A comprising (i) at least one polyurethane polymer P containing isocyanate groups and (ii) at least one latent polyamine LA; and
b) a second component B comprising (i) at least one acid K and (ii) water,
   has a high early strength at a very early point in time after the mixing of the two components A and B. By way of example, with a composition of this kind, it is possible to achieve an early strength of 1 MPa at room temperature just 30 minutes after application, which is not achieved with compositions of the kind described in WO 03/059978 A1, for example. Such rapid curing of a polyurethane composition with elastic properties was hitherto achievable only with conventional two-component compositions in which a first component containing isocyanate groups is mixed with a second component containing a polyamine, where appropriate in latent form, something which requires a substantially more complicated application process.

Component A of the two-component composition described cures even with atmospheric moisture alone, the fully cured component A possessing substantially the same mechanical properties as the fully cured two-component composition composed of both components, A and B. This substantially simplifies the application of these compositions. Hence the composition is hardly sensitive to fluctuations in the metering of the individual components A and/or B, since too low or too high a fraction of component B in relation to component A probably has a certain influence on the cure rate, but does not substantially alter the mechanical properties of the fully cured composition. Likewise it is possible to prevent clogging of the mixing nozzle in the case of brief interruptions to operation, by flushing the nozzle with component A alone before operation is interrupted.

A further advantage of the two-component composition described is that there is very great flexibility in the setting of the cure rate. Thus, for example, a standardized component A, also employed as a one-component moisture-curing adhesive or sealant, can be greatly accelerated in its cure rate, with a small amount of a second component B, comprising at least one acid K and water, without component A having to be reformulated. The fine-tuning of the cure rate is possible directly at the application stage, by the alteration of the fraction of component B such that the desired cure rate is achieved, or by the use of a component B having an acid K content adapted to the desired cure rate.

The preferred embodiment of the two-component composition described, comprising polyaldimines as latent polyamine LA in component A, the polyaldimines being obtainable from aldehdyes ALD which do not have any C—H moieties positioned a to the carbonyl group, produces storage-stable first components A, even when they contain highly reactive aromatic isocyanate groups such as those of TDI and MDI.

The particularly preferred embodiment of the two-component composition described in which odorless aldehydes ALD of the restricted formula (Ib) are used for the preparation of the polyaldimine of component A produces compositions which cure odorlessly, which for many applications is a great advantage or a vital prerequisite.

Particular preference is given to two-component compositions which as latent polyamines LA in component A comprise polyaldimines which are preferentially obtainable from aldehydes ALD which do not have any C—H moieties positioned a to the carbonyl group, and also which as acid K in component B comprise salicylic acid.

### EXAMPLES

### Description of Test Methods

The extrusion force of component A was determined on a freshly opened, room-temperature cartridge in each case, the composition being pressed at the cartridge tip at 23° C., without addition of a hydrous component, through a 5 mm opening. Extrusion was carried out by a tensile testing machine with a constant speed of 60 mm/min. The change in the extrusion force is a measure of the storage stability of a polyurethane composition.

The early strength was determined as follows. First of all, in each case, two glass plates with dimensions of 40×100×6 mm were pretreated with Sika® Aktivator (available from Sika Schweiz AG) on the side on which bonding was to take place. Following a flash-off time of 10 minutes, the adhesive was applied in the form of a triangular bead along the long edge of one of the glass plates. After about a minute, the applied adhesive was pressed to a bond thickness of 5 mm (corresponding to a bonding width of approximately 1 cm) using the second glass plate and a tensile machine (Zwick), and the assembly was then stored at 23° C. and 50% relative humidity. After the stated time (number of minutes), three of the bonded glass plates per batch were pulled apart with a pulling speed of 200 mm/min, an operation for which the maximum force in MPa was recorded and was averaged over the three samples. For this experimental setup the following relationship applies: 1 MPa corresponds to 100 N/cm.

The open time (the time within which a two-component adhesive must be used) was determined as follows: at 23° C. and 50% relative humidity, the adhesive was applied in the form of a triangular bead with a cross section of approximately 1 cm to a glass plate. At regular intervals, glass plates coated with a bead of adhesive were each covered with a second glass plate, which was pressed immediately to a bond thickness of 5 mm. The force applied during this procedure was recorded. When a pressing force of 0.04 MPa is exceeded, the open time of the adhesive is past.

Taken as a measure of the cure rate is the speed at which the early strength is developed, and/or the duration of the open time.

The tensile shear strength was measured by a method based on DIN EN 1465. Float glass plates were used which had been cleaned beforehand with Sika Cleaner 205. The glass plates were arranged, in the manner described in the standard, such that an adhesive-filled overlap was formed with dimensions of 10 to 12 mm in width, 25 mm in length, and 4 to 5 mm in thickness. The test specimens produced in this way were stored under standard conditions (23±1° C., 50±5% relative humidity) for 7 days for curing, and then were pulled apart with a crosshead speed of 20 mm/min until the breaking point was reached.

The tensile strength and the elongation at break were determined in accordance with DIN 53504 (pulling speed: 200 mm/min) on films with a thickness of 2 mm that had been cured under standard conditions (23±1° C., 50±5% relative humidity) for 14 days.

### a) Preparation of Polyurethanepolymers P

### Polymer P1

1300 g of Acclaim® 4200 N polyol (Bayer; low monol polyoxypropylenediol, OH number 28.0 mg KOH/g, water content 0.02% by weight), 2590 g of Caradol® MD34-02 polyol (Shell; polyoxypropylene-polyoxyethylene-triol, ethylene oxide-terminated, OH number 35.0 mg KOH/g, water content 0.03% by weight), 610 g of 4,4′-methylenediphenyl diisocyanate (MDI; Desmodur® 44 MC L, Bayer), and 500 g of diisodecyl phthalate (DIDP; Palatinol® Z, BASF) were reacted by a known method at 80° C. to give an NCO-terminated polyurethane polymer. The reaction product had a titrimetrically determined free isocyanate group content of 2.05% by weight.

### Polymer P2

1230 g of Acclaim® 4200 N polyol (Bayer; low monol polyoxypropylenediol, OH number 28.0 mg KOH/g, water content 0.02% by weight), 615 g of Caradol® MD34-02 polyol (Shell; polyoxypropylene-polyoxyethylene-triol, ethylene oxide-terminated, OH number 35.0 mg KOH/g, water content 0.03% by weight), and 155 g of Desmodur® T-80 P (Bayer; 2,4- and 2,6-tolylene diisocyanate in a ratio of 80:20) were reacted by a known method at 80° C. to give an NCO-terminated polyurethane polymer. The reaction product had a titrimetrically determined free isocyanate group content of 1.55% by weight.

### b) Preparation of the Polyaldimine

A round-bottomed flask was charged under nitrogen with 625 g (2.20 mol) of 2,2-dimethyl-3-lauroyloxypropanal. With vigorous stirring, 250 g (2.10 mol of NH₂) of Jeffamine® D-230 (Huntsman; alpha,omega-polyoxypropylenediamine, amine equivalent weight 119 g/eq) were added slowly from a dropping funnel. Thereafter, at 80° C., the volatile constituents were distilled off completely under reduced pressure. This gave 837 g of a yellowish reaction product which was liquid at room temperature and had an aldimine content, determined as the amine content, of 2.5 mmol NH₂/g.

c) Preparation of the urea thickener paste

A vacuum mixer was charged with 1000 g of diisodecyl phthalate (DIDP; Palatinol® Z, BASF) and 160 g of 4,4′-methylenediphenyl diisocyanate (MDI; Desmodur® 44 MC L, Bayer) and this initial charge was gently heated. Then 90 g of monobutylamine were added slowly dropwise with vigorous stirring. The white paste formed was stirred further for an hour, under vacuum and with cooling, after which it was cooled and subsequently used further.

### d) Preparation of Component A-1.

In a vacuum mixer, 2900 g of polymer P1, 550 g of polymer P2, 2584 g of urea thickener paste, 418 g of the above-described polyaldimine, 3200 g of chalk (Omya® 5 GU, Omya; dried), 320 g of hydrophobicized fumed silica (Aerosil® R972, Degussa-Huls AG), and 28 g of a solution of salicylic acid (5% by weight) in dioctyl adipate were processed in the absence of moisture to form a lump-free, homogenous paste which was stored in the absence of moisture.

The extrusion force on the day following preparation was 500 N; after storage at 70° C. for 2 days, the extrusion force was 685 N.

### e) Preparation of the Second Component B

### Component B-1 (Inventive)

In a vacuum mixer, 54 g of salicylic acid, 785 g of deionized water, 2446 g of diisodecyl phthalate (DIDP; Palatinol® Z, BASF), 690 g of fumed silica (Aerosil® 200, Degussa-Hüls AG) and 1025 g of chalk (Omya® 5 GU, Omya) were processed to a lump-free paste and stored in an impervious container.

Component B-2 (Comparative, without Acid K)

In a vacuum mixer, 785 g of deionized water, 2500 g of diisodecyl phthalate (DIDP; Palatinol® Z, BASF), 690 g of fumed silica (Aerosil® 200, Degussa-Hüls AG) and 1025 g of chalk (Omya® 5 GU, Omya) were processed to a lump-free paste and stored in an impervious container.

### Component B-3 (Comparative, Prior Art WO 03/059978A1)

An organic polymer containing ionic groups and having an average molecular weight of approximately 20 000 was prepared by polyaddition of isophorone diisocyanate (IPDI; Vestanat® IPDI, Degussa) with Caradol® ED56-11 polyol (Shell), aminoethylethanolamine and 2,2-bis-(hydroxymethyl)propionic acid in N-methylpyrrolidone, followed by neutralization with triethylamine and addition of water to a water content of 25% by weight. This gave a homogeneous paste which remained unchanged even on prolonged storage and did not give off water.

### f) Mixing and Testing of the Adhesives

### Examples 1 to 4 (Inventive) and Examples 5 and 6 (Comparative Examples)

Component A-1 was mixed in each case with different amounts of component B-1 and/or B-2, the amounts being apparent from table 1. The individual components were conveyed by means of a metering pump and mixed substantially homogeneously by means of a suitable static mixer. The early strength results are shown in table 2, the further test results in table 3.

### Example 7

### Comparative Example

Component A-1 was mixed as per the figures in table 1 with component B-3. The two components, A-1 and B-3, were mixed continuously during the application by means of a metering attachment of the Sika® booster type (available from Sika Schweiz AG), where the substance present in the integrated container had been replaced by component B-3. The Sika® booster thus modified was mounted on a cartridge containing component A-1 and was operated passively by the application of pressure to the cartridge by means of a commercially customary cartridge press. Screwed onto the exit aperture of the modified Sika® booster was a static mixer having a diameter of 16 mm and 6 mixing elements, corresponding to a mixing path of 70 mm. This mixing device mixed the two components A-1 and B-3 of the two-component composition in a substantially laminar manner.

The early strength results are shown in table 2, the further test results in table 3.

### Example 8

### Comparative, Reference

Component A-1 was tested as a one-component moisture-curing adhesive without the admixture of a second component B. The early strength results are indicated in table 2; the further test results are shown in table 3.

TABLE 1
Composition of the adhesives of examples 1 to 4 and
of comparative examples 5 to 8 in parts by weight.

| Example | 1 | 2 | 3 | 4 | 5 (comp.) | 6 (comp.) | 7 (comp.) | 8 (ref.) |
|---|---|---|---|---|---|---|---|---|
| Component A-1 | 100 | 100 | 100 | 100 | 100 | 100 | 100 | 100 |
| Component B-1 | 2 | 3 | 4 | 5 | — | — | — | — |
| Component B-2 | — | — | — | — | 3 | 4 | — | — |
| Component B-3 | — | — | — | — | — | — | 2 | — |

TABLE 2
Early strength of the adhesive of examples 1 to 4 and of
comparative examples 5 to 8, determined after different times.

| Example | | | | | | | |
|---|---|---|---|---|---|---|---|
| | | | | 5 | 6 | 7 | 8 |
| 1 | 2 | 3 | 4 | (comp.) | (comp.) | (comp.) | (ref.) |

Early strength [MPa] after:

| | | | | | | | | |
|---|---|---|---|---|---|---|---|---|
| 30 min | 0.15 | 0.6 | 0.9 | 1.1 | 0.1 | 0.2 | | |
| 90 min | | | 1.7 | | | | 0.3 | |
| 120 min | | | | | | | 0.5 | 0.1 |
| 180 min | | | 2.3 | | | | 0.7 | |
| 240 min | | | 2.5 | | | | 1.0 | 0.3 |

TABLE 3
Open time and mechanical properties of the adhesives of
examples 1 to 4 and of comparative examples 5 to 8.

| | Example | | | | | | | |
|---|---|---|---|---|---|---|---|---|
| | | | | | 5 | 6 | 7 | 8 |
| | 1 | 2 | 3 | 4 | (comp.) | (comp.) | (comp.) | (ref.) |
| Open time | 10 | 5 | 3 | 2 | 13 | 10 | 20 | 45¹ |
| [min.] | | | | | | | | |
| Tensile | | 2.2 | 2.2 | 2.2 | | | 2.2 | 2.4 |
| shear | | | | | | | | |
| strength | | | | | | | | |
| [MPa] | | | | | | | | |
| Tensile | | 3.8 | 3.7 | 3.6 | | | | 3.8 |
| strength | | | | | | | | |
| [MPa] | | | | | | | | |
| Elongation | | 480 | 450 | 450 | | | | 500 |
| at break | | | | | | | | |
| [%] | | | | | | | | |

¹Skinover time (at 23° C. and 50% relative humidity)

From tables 2 and 3 it is evident that examples 1 to 4, which contain the component B-1 containing water and salicylic acid, cure rapidly, the cure rate rising significantly as the proportion of component B-1 goes up. This is evident both from the development of the early strengths and from the respective open times.

Examples 2 and 3, which contain 3 and 4 parts by weight of component B-1 per 100 parts by weight of component A-1, have early strengths of 0.6 and 0.9 MPa after just 30 minutes, and have open times of 5 minutes and 3 minutes, whereas comparative examples 5 and 6, which contain the respective amounts of component B-2 (without salicylic acid), have only early strengths of 0.1 and 0.2 MPa after 30 minutes and have open times of 13 minutes and 10 minutes. The salicylic acid in component B-1 therefore brings about a sharp acceleration in curing.

Comparative example 7 contains component B-3, which has been incorporated by mixing in a substantially laminar manner. The cure rate is significantly slower than, for example, in the case of example 2, which contains a comparable amount of water in component B. The development of the early strength is severely retarded, and the open time as well is much longer.

Comparative example 8 contains no component B. Component A-1 is cured by means of atmospheric moisture, as a one-component adhesive. The cure rate is correspondingly low in comparison with the two-component adhesives. The values for the tensile shear strength, the tensile strength, and the elongation at break, however, are not different, to a relevant extent, from the corresponding values of the examples cured in two-component form.

For all of the adhesives of examples 1 to 8, no odor is perceptible either during or after curing.

The invention is of course not restricted to the exemplary embodiments described and shown. It will be understood that the features of the invention as identified above can be used not only in the specific combination indicated but also in other modifications, combinations and amendments, or else alone, without departing from the scope of the invention.

1. A two-component composition composed of
a) a first component A comprising
(i) at least one polyurethane polymer P containing isocyanate groups and
(ii) at least one latent polyamine LA, and
b) a second component B comprising
(i) at least one acid K and
(ii) water.

2. The two-component composition of claim 1, wherein the latent polyamine LA is a polyaldimine.

3. The two-component composition of claim 1, wherein the latent polyamine LA is a polyaldimine which is obtainable from at least one polyamine PA having aliphatic primary amino groups and at least one aldehyde ALD which does not have a C—H moiety positioned α to the carbonyl group.

4. The two-component composition of claim 1, wherein the latent polyamine LA is a polyaldimine which is obtainable from the reaction of an amine C of the formula (III) and an aldehyde ALD which does not have a C—H moiety positioned a to the carbonyl group, 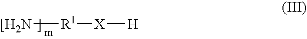
where
m stands for 1 or 2,
R¹ stands for an (m+1)-valent hydrocarbon radical having 2 to 12 C atoms which optionally contains at least one heteroatom, and
X stands for O, S or N—R⁶,
where R⁶
either stands for a monovalent hydrocarbon radical having 1 to 20 C atoms which optionally has at least one carbonate, nitrile, nitro, phosphonate, sulfone or sulfonate group,
or stands for —R⁷—NH₂, where R⁷ stands for a divalent hydrocarbon radical which optionally contains heteroatoms,
and subsequent reaction of the resulting aldimine with a polyisocyanate.

5. The two-component composition of claim 3, wherein the aldehyde ALD has the formula (I) or (II), 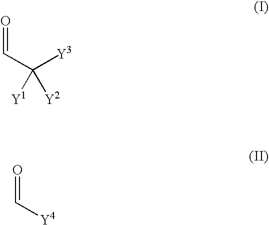
where
Y¹ and Y² either
independently of one another each stand for a monovalent hydrocarbon radical having 1 to 12 C atoms,
or together form a divalent hydrocarbon radical having 4 to 20 C atoms which is part of an optionally substituted carbocyclic ring having 5 to 8 C atoms, and Y³ stands for a monovalent hydrocarbon radical which optionally has at least one heteroatom; and
Y⁴ either
stands for a substituted or unsubstituted aryl or heteroaryl group which has a ring size of between 5 and 8 atoms;
or stands for 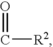
where R stands for a hydrogen atom or for an alkoxy group;
or stands for a substituted or unsubstituted alkenyl or arylalkenyl group having at least 6 C atoms.

6. The two-component composition of claim 5, wherein the aldehyde ALD has the formula (Ia), 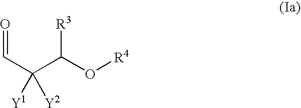
where
R³ stands for a hydrogen atom or for an alkyl or arylalkyl group and
R⁴ stands for an alkyl or arylalkyl group.

7. The two-component composition of claim 5, wherein the aldehyde ALD has the formula (Ib), 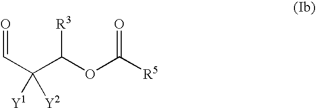
where
R³ stands for a hydrogen atom or for an alkyl or arylalkyl group and
R⁵ either stands for
a hydrogen atom or
an alkyl or arylalkyl or aryl group, optionally having at least one heteroatom, and optionally having at least one carboxyl group, and optionally having at least one ester group,
or stands for a singly or multiply unsaturated linear or branched hydrocarbon chain.

8. The two-component composition of claim 7, wherein the composition cures odorlessly and in that
R⁵ either
stands for a linear or branched alkyl chain having 11 to 30 carbon atoms, optionally with at least one heteroatom, or
stands for a singly or multiply unsaturated linear or branched hydrocarbon chain having 11 to 30 carbon atoms.

9. The two-component composition of claim 1, wherein the polyurethane polymer P is prepared from at least one polyisocyanate and at least one polyol.

10. The two-component composition of claim 9, wherein the polyol has an average OH functionality of 1.6 to 3.

11. The two-component composition of claim 9, wherein the polyol is a polyoxyalkylenepolyol.

12. The two-component composition of any one of claim 9, wherein said polyisocyanate is at least one aromatic polyisocyanate.

13. The two-component composition of claim 1, wherein the latent polyamine LA is present in a ratio of 0.1 to 1.0 equivalent of blocked amino groups per equivalent of isocyanate groups.

14. The two-component composition of claim 1, wherein the acid K is present in component B in an amount of 0.1% to 10% by weight based on component B.

15. The two-component composition of claim 1, wherein the acid K is an organic acid.

16. The two-component composition of claim 15, wherein the acid K is a carboxylic acid or a sulfonic acid.

17. The two-component composition of claim 16, wherein the acid K is benzoic acid or salicylic acid.

18. The two-component composition of claim 1, wherein the water is present in component B in an amount such that the ratio of the amount of water introduced by component B to the amount of water needed for complete curing of component A is 0.5 to 10.

19. The two-component composition of claim 1, wherein component B is present in an amount of 0.5 to 10 parts by weight per 100 parts by weight of component A.

20. (canceled)

21. (canceled)

22. (canceled)

23. A method of adhesive bonding comprising the steps of
(i) applying a composition of claim 1 to a substrate S1 and/or a substrate S2,
(ii) joining the parts within the open time,
(ii) curing the composition,
the substrates S1 and S2 being alike or different from one another.

24. A method of sealing comprising the steps of
(i) applying a composition of claim 1 between a substrate S1 and a substrate S2,
(ii) curing the composition,
the substrates S1 and S2 being alike or different from one another.

25. The method of claim 23, wherein at least one of the substrates, S1 or S2, is glass, glass ceramic, concrete, mortar, brick, tile, plaster, a natural stone, a metal or an alloy, a wood, a plastic, a powdercoating, or a paint or a finish.

26. A bonded or sealed article produced by means of a method of adhesive bonding or sealing of claim 23.

27. The bonded or sealed article of claim 26, wherein the article is a built structure, or a part thereof, or an industrial or consumer good or a means of transport, or a part thereof.
